(19) United States
(12) Patent Application Publication
(10) Pub. No.: US 2024/0408856 A1
(43) Pub. Date: Dec. 12, 2024

(54) PANEL AND METHODS FOR MANUFACTURING A PANEL

(71) Applicant: UNILIN, BV, Wielsbeke (BE)

(72) Inventors: Kristof VAN VLASSENRODE, Deinze (BE); Jan DE RICK, Geraardsbergen (BE)

(21) Appl. No.: 18/692,877

(22) PCT Filed: Sep. 21, 2022
(86) PCT No.: PCT/IB2022/058907

§ 371 Date: Mar. 18, 2024

Related U.S. Application Data
(60) Provisional application No. 63/246,895, filed on Sep. 22, 2021.

(30) Foreign Application Priority Data
Oct. 22, 2021 (BE) 2021/5830

(51) Int. Cl. B32B 27/06; B29C 48/00; B29C 48/08; B29C 48/21; B29K 27/06; B29K 105/04; B29K 105/16; B29K 509/00; B29L 31/00; B32B 3/06; B32B 5/18; B32B 7/022; B32B 27/20; B32B 27/22; B32B 27/30; E04F 15/02; E04F 15/10; E04F 15/20

(52) U.S. Cl. CPC B32B 27/065; B32B 3/06; B32B 5/18; B32B 7/022; B32B 27/20; B32B 27/22; B32B 27/304; E04F 15/02038; E04F 15/107; E04F 15/206; B29C 48/0021; B29C 48/08; B29C 48/21; B29C 2948/92266; B29K 2027/06; B29K 2105/04; B29K 2105/16; B29K 2509/00; B29K 2995/0046; B29K 2995/007; B29L 2031/732; B29L 2031/776; B32B 2264/104; B32B 2266/0214; B32B 2307/536; B32B 2307/54; B32B 2307/7376; B32B 2607/00; E04F 2201/0153; E04F 2201/023; E04F 2201/042; E04F 2201/043

(57) ABSTRACT

A panel including a primary and a secondary substrate layer, an intermediate layer, and a top layer. The intermediate layer is located between the primary and secondary substrate layers. The top layer is applied on the secondary substrate layer. The intermediate layer has at least one of the following properties: the intermediate layer has a Shore A hardness that is 10 units lower than the Shore A hardness of the primary and/or secondary substrate layer; the intermediate layer has an elastic modulus that is at least 10.0% lower than the elastic modulus of the primary and/or secondary substrate layer; the intermediate layer includes a material with a substantially open cell structure; or the intermediate layer includes a foamed thermoplastic material or a foamed thermosetting material. Methods are provided for manufacturing the panel.

This invention relates to a panel and methods for manufacturing a panel.

WO 97/47834 describes a floor panel for assembling a floating floor. However, the floor panel as described herein has the drawbacks that the substrate used herein, in particular MDF or HDF (Medium Density Fiberboard or High Density Fiberboard) is sensitive to moisture, and the structure of said panel gives rise to walking and/or tapping noises.

EP 1 938 963 describes a plastic floor panel for assembling a floating floor. Although the floor panel according to EP '963 is more resistant to moisture and gives rise to less tapping noise, said floor panel has limited stiffness and high deformability, which may cause problems in application thereof on uneven surfaces. In particular, irregularities of the substrate may migrate onto the surface of the floor panel (telegraphy) and/or local loads such as table or chair legs may cause permanent deformation (indentation) in the surface of the floor panel.

EP 3 405 346 describes a plastic floor panel that has good resistance to moisture and has improved stiffness and lower deformability, which is advantageous for minimizing telegraphy and/or indentation. However, the floor panel as described in EP '346 still gives rise to acoustic discomfort, in particular an increase in walking and/or tapping noises.

The invention thus aims firstly to provide an alternative material, in particular a panel, wherein according to various preferred embodiments, a solution may be obtained for the problems relating to walking and/or tapping noises of known panels. Some embodiments in addition aim at improved stiffness of these panels, wherein adverse effects such as telegraphy and/or indentation are minimized and/or counteracted.

For this purpose the invention relates according to its first independent aspect to a panel comprising a primary and a secondary substrate layer, an intermediate layer, and a top layer, wherein said intermediate layer is located between said primary and secondary substrate layer, and wherein said top layer is applied on the secondary substrate layer, and wherein the intermediate layer has at least one of the following properties:
the intermediate layer has a Shore A hardness that is 10 units lower than the Shore A hardness of the primary and/or secondary substrate layer;
the intermediate layer has an elastic modulus that is at least 10.0% lower than the elastic modulus of the primary and/or secondary substrate layer;
the intermediate layer comprises a material with a substantially open cell structure; or
the intermediate layer comprises a foamed thermoplastic material or a foamed thermosetting material.

In light of the present invention, the term “panel” indicates a material in sheet form, where said material in sheet form may be either in cut form, for example cut to measure, or in non-cut form. In particular, reference is made herein to, among other things, Luxury Vinyl Tiles (LVT), Stone Polymer Composite (SPC), or other polymer-based panels. The “top layer” as described herein possibly comprises finishing layers such as a decorative layer, a wear-resistant layer, a varnish coat, or combinations thereof. According to some embodiments, the primary and/or secondary substrate layer comprise a thermoplastic material selected from the group of polyvinyl chloride (PVC), polyethylene (PE), high-density polyethylene (HDPE), polypropylene (PP), polyester, polyethylene terephthalate (PET), polyurethane (PU) and/or elastomer. The most preferred thermoplastic material is PVC.

The intermediate layers as described herein ensure that the panels display better sound damping. This is particularly important for panels that are used as floor panels. The intermediate layers as described herein ensure additionally and/or alternatively that the panels display improved walking comfort.

According to some embodiments, the intermediate layer has a Shore A hardness that is 10 units lower than the Shore A hardness of the primary and/or secondary substrate layer. In light of the present invention, the term “Shore A hardness” indicates the hardness of the intermediate layer as determined with a Shore durometer of type A. The methodology for determining the Shore A hardness, as well as the specific requirements that are imposed on a Shore durometer of type A, are defined in ASTM standard D2240, in particular ASTM standard D2240-15R21. Preferably the intermediate layer has a Shore A hardness that is 11 units lower than the Shore A hardness of the primary and/or secondary substrate layer, more preferably 12 units lower, even more preferably 13, 14, 15, 16, 17, 18, 19 or 20 units lower. With increasing preference, the various embodiments as described herein ensure a further improvement in the sound damping and/or walking comfort of the panels.

According to a further or another embodiment, the intermediate layer has an elastic modulus that is at least 10.0% lower than the clastic modulus of the primary and/or secondary substrate layer. A suitable method for measuring the clastic modulus is ASTM standard E111-17. The intermediate layer, and in particular the lower elastic modulus relative to the primary and/or secondary substrate layer, provides an improvement in the sound-absorbing properties of the panel, and improves the walking comfort, in particular when the panel is used as a floor panel. Preferably the intermediate layer has an elastic modulus that is at least 11.0% lower than the elastic modulus of the primary and/or secondary substrate layer, more preferably 12.0% lower, even more preferably 13.0%, 14.0% or 15.0% lower.

According to some embodiments, the intermediate layer comprises a material with a substantially open cell structure. According to some embodiments the intermediate layer comprises a foamed thermoplastic material or a foamed thermosetting material. These embodiments provide a panel that has improved sound damping and/or improved walking comfort.

According to a further or another embodiment, the intermediate layer has a Shore A hardness that is 10 units lower than the Shore A hardness of the secondary substrate layer and/or the intermediate layer has an elastic modulus that is at least 10.0% lower than the elastic modulus of the secondary substrate layer. The panel then has a relatively hard secondary substrate layer, and then imparts sufficient stiffness to the panel, wherein the relatively soft intermediate layer imparts improved sound damping and/or improved walking comfort to the panel.

According to a further or another embodiment, the intermediate layer comprises a foamed thermoplastic material or a foamed thermosetting material, wherein the foamed thermoplastic material or the foamed thermosetting material has an empty cell volume between 10.0 and 80.0 vol %. The empty cell volume in the range as described herein is optimally suitable for improving the sound-absorbing properties of the panel.

According to a further or another embodiment, the aforementioned foamed thermoplastic material is selected from the group of ethylene vinyl acetate (EVA), irradiation-crosslinked polyethylene (IXPE), irradiation-crosslinked polypropylene (IXPP), expanded polyethylene (EPE), expanded polyethylene copolymer (EPC), polypropylene (PP), polyvinyl chloride (PVC), PVC-plastisol, polyurethane (PU), or combinations thereof. These materials are optimally suitable as intermediate layer and provide the panel with improved sound-absorbing properties and/or improved walking comfort. Preferably, the aforementioned foamed thermoplastic material is selected from the group of ethylene vinyl acetate (EVA), irradiation-crosslinked polyethylene (IXPE), expanded polyethylene (EPE), polyvinyl chloride (PVC), PVC-plastisol, polyurethane (PU), or combinations thereof. Most preferably, the aforementioned foamed thermoplastic material is ethylene vinyl acetate (EVA).

According to a further or another embodiment, the aforementioned foamed thermoplastic material has a density that is between 100 and 200 kg/m³, preferably between 100 and 150 kg/m³, more preferably between 120 and 140 kg/m³. With increasing preference the aforementioned densities are extremely advantageous in providing improved sound-absorbing properties and/or improved walking comfort.

According to some embodiments, said primary substrate layer comprises polyvinyl chloride (PVC). Preferably, the polyvinyl chloride has a concentration of at least 95 wt %, more preferably at least 99 wt %, most preferably 100 wt %.

It is possible that the primary substrate layer further comprises one or more fillers selected from the group of inorganic fillers, such as chalk, lime and/or talc, or organic fillers, such as wood, bamboo and/or cork, or mineral fillers. According to a further or other embodiments, said primary substrate layer comprises polyvinyl chloride (PVC) and calcium carbonate (CaCO₃) as filler.

According to some embodiments, the calcium carbonate (CaCO₃) has a concentration of at most 80 wt % and the polyvinyl chloride (PVC) has a concentration of at least 20 wt %. Preferably, the calcium carbonate (CaCO₃) has a concentration between 10 and 80 wt % and the polyvinyl chloride (PVC) has a concentration between 20 and 90 wt %.

More preferably, the calcium carbonate (CaCO₃) has a concentration between 60 and 80 wt % and the polyvinyl chloride (PVC) has a concentration between 20 and 40 wt %. It was found that particularly good stiffness and/or stability is achieved when the proportion of calcium carbonate is greater than the proportion of PVC. Preferably, the calcium carbonate (CaCO₃) has a concentration between 65 and 80 wt % and the polyvinyl chloride (PVC) has a concentration between 20 and 35 wt %. More preferably, the calcium carbonate (CaCO₃) has a concentration between 70 and 80 wt % and the polyvinyl chloride (PVC) has a concentration between 20 and 30 wt %. Most preferably the calcium carbonate (CaCO₃) has a concentration of 75 wt % and the polyvinyl chloride (PVC) has a concentration of 25 wt %.

According to some embodiments, said secondary substrate layer comprises polyvinyl chloride (PVC). According to some embodiments, the polyvinyl chloride has a concentration of at least 95 wt %, more preferably at least 99 wt %, most preferably 100 wt %.

Preferably, said secondary substrate layer comprises plasticizers in an amount of less than 15 phr, preferably of less than 10 phr, more preferably of less than 5 phr.

The various embodiments as described herein provide a secondary substrate layer that imparts sufficient stability and/or stiffness to the panel.

According to a further or another embodiment, said secondary substrate layer is configured to increase the stiffness of the panel, wherein the secondary substrate layer has at least one of the following properties:
the secondary substrate layer comprises a reinforcing layer;
the secondary substrate layer comprises calcium carbonate (CaCO₃) as filler; or
the secondary substrate layer has a thickness of at least 2.0 mm.

According to some embodiments, said secondary substrate layer comprises a reinforcing layer. A suitable reinforcing layer is for example a glass fiber layer. The secondary substrate layer possibly comprises alternative and/or additional reinforcing layers in order to increase the stiffness further.

According to some embodiments, said secondary substrate layer comprises calcium carbonate (CaCO₃) as filler, in which the calcium carbonate (CaCO₃) has a concentration of at most 80 wt % and the polyvinyl chloride (PVC) has a concentration of at least 20 wt %. Preferably, the calcium carbonate (CaCO₃) has a concentration between 10 and 80 wt % and the polyvinyl chloride (PVC) has a concentration between 20 and 90 wt %.

More preferably, the calcium carbonate (CaCO₃) has a concentration between 60 and 80 wt % and the polyvinyl chloride (PVC) has a concentration between 20 and 40 wt %. It was found that particularly good stability and/or stiffness is achieved when the proportion of calcium carbonate is greater than the proportion of PVC. Preferably, the calcium carbonate (CaCO₃) has a concentration between 65 and 80 wt % and the polyvinyl chloride (PVC) has a concentration between 20 and 35 wt %. More preferably, the calcium carbonate (CaCO₃) has a concentration between 70 and 80 wt % and the polyvinyl chloride (PVC) has a concentration between 20 and 30 wt %. Most preferably the calcium carbonate (CaCO₃) has a concentration of 75 wt % and the polyvinyl chloride (PVC) has a concentration of 25 wt %.

According to a further or another embodiment, the secondary substrate layer has a thickness of at least 2.0 mm, which imparts improved stiffness and/or stability to the panel. Preferably, the secondary substrate layer has a thickness of at least 2.1 mm, 2.2 mm, 2.3 mm, 2.4 mm or 2.5 mm. According to some embodiments, the secondary substrate layer may, however, also have a thickness that is less than 2.0 mm. In particular, it is possible that the secondary substrate layer has a thickness that is between 0.5 and 2.0 mm, preferably between 0.5 and 1.5 mm, more preferably between 0.5 and 1.0 mm, most preferably between 0.5 and 0.8 mm. A secondary substrate layer with a small thickness according to the present embodiment is particularly advantageous if it is combined with a high filler content. In particular it is possible that the secondary substrate layer comprises calcium carbonate (CaCO₃) at a concentration between 60 and 80 wt % and comprises polyvinyl chloride (PVC) at a concentration between 20 and 40 wt %, wherein the secondary substrate layer has a thickness between 0.5 and 2.0 mm, preferably between 0.5 and 1.5 mm, more preferably between 0.5 and 1.0 mm, most preferably between 0.5 and 0.8 mm.

According to a further or another embodiment, the thickness of the secondary substrate layer and the thickness of the intermediate layer are in proportion to one another according to a ratio that is between 10:10 and 2:10, preferably between 10:10 and 3:10, more preferably between 10:10 and 4:10. In the respective embodiment an optimal equilibrium is obtained between sound-absorbing properties, walking comfort and strength and/or stability of the panel. Most preferably, the thickness of the secondary substrate layer and the thickness of the intermediate layer are in proportion to one another according to a ratio that is between 8:10 and 4:10.

According to a practical embodiment, it is possible that the intermediate layer has a thickness between 0.5 and 2.0 mm, preferably between 0.7 and 1.8 mm, more preferably between 0.9 and 1.6 mm, for example such as 1.0 mm or 1.5 mm.

According to a further or another embodiment, the aforementioned panel is provided on at least two opposite edges with coupling means, wherein on the respective edges, locking is brought about at least in a vertical direction perpendicular to the plane of the panels and/or at least in a horizontal direction in the plane of the panels and perpendicular to the edges. Owing to the coupling means as described herein, different panels can be coupled to each other in a simple and stable manner.

Preferably at least one of the aforementioned edges is provided with a groove, wherein this groove is flanked by an upper lip and a lower lip, wherein said intermediate layer extends substantially through the upper lip. More preferably, the lower surface of the upper lip is formed at least partially in said primary substrate layer. Even more preferably, the aforementioned upper lip is formed substantially in the primary substrate layer, the intermediate layer and the secondary substrate layer. The embodiments as described herein have the advantage that the upper lip has excellent stiffness, so that good-quality, durable coupling is obtained between the coupling means. Furthermore, the presence of the intermediate layer in the upper lip ensures that when coupling and/or uncoupling adjacent floor panels, the upper lip allows slight compression and/or deformation, so that this coupling and/or uncoupling takes place efficiently, and wherein the risk of permanent deformation of the upper lip, for example through breakage, is reduced.

According to some embodiments, in a coupled state between two adjacent panels, the intermediate layers of said adjacent panels press against each other, wherein a seal forms along the edges of said panels. Said seal further improves the sound-absorbing properties between adjacent panels.

According to some other embodiments, in a coupled state between two adjacent panels, the intermediate layers of said adjacent panels do not touch each other, wherein a space forms between said intermediate layers along the edges of said panels.

According to some embodiments, the coupling means are configured for coupling together the first edge of such a panel to the second edge of another such panel, preferably wherein the coupling parts comprise locking parts for locking such a panel coupled with its first edge to the second edge of another such panel in the direction perpendicular to the plane of the coupled panels and/or in the direction perpendicular to the coupled edges and in the plane of the panels, and wherein on the first edge there is a coupling part in the form of a tongue and on the second edge there is a coupling part in the form of a groove, wherein the groove is delimited by a lower lip and an upper lip, wherein the upper lip is located on the upper side of the panel, and wherein on the upper side the panel comprises a first sealing face on the first edge, wherein the distal end of the upper lip comprises a second sealing face, wherein the first sealing face and the second scaling face are configured so that in the coupled state of such a panel with its first edge on the second edge of another such panel, the first sealing face of said panel comes into contact with or is tightly against the second sealing face of the other such panel.

The coupling means as described herein are in some embodiments provided on a first, and a second opposite edge. According to some embodiments the coupling means as described herein are on a first, and a second opposite edge, as well as on a third, and a fourth opposite edge.

According to a further or another embodiment, said panel is a floor panel or wall panel.

According to a second independent aspect, the present invention relates to a method for manufacturing a panel, comprising the steps:
extruding a primary substrate layer,
extruding an intermediate layer,
extruding and/or laminating a secondary substrate layer, and
laminating a top layer,
   wherein at least the primary substrate layer and the intermediate layer are formed by coextrusion.

Coextrusion is a particularly suitable and efficient way of forming two or more layers bonded together, in particular the primary substrate layer and the intermediate layer, wherein it is in addition possible that the respective compositions of the primary substrate layer and the secondary substrate layer differ substantially from each other.

According to a preferred embodiment, the primary substrate layer, the intermediate layer and the secondary substrate layer are formed by coextrusion. Manufacture of panels is then further simplified and the efficiency thereof is improved.

According to another preferred embodiment, the secondary substrate layer is laminated. Laminating allows the secondary substrate layer to be fastened in an efficient manner to the assembly of the primary substrate layer and the intermediate layer in a separate process step.

According to some embodiments, said layers that are formed by coextrusion are formed by a single die. According to some embodiments, said layers that are formed by coextrusion are formed by two or more separate dies. Preferably said dies relate to one or more slot dies.

According to a third independent aspect, the present invention relates to a method for manufacturing a panel, comprising the steps:
extruding a first substrate layer,
laminating an intermediate layer,
laminating a secondary substrate layer, and
laminating a top layer,
   wherein at least the intermediate layer and the secondary substrate layer are laminated together on the primary substrate layer in the form of a laminated complex.

The term “laminated complex” indicates a complex of two or more layers formed beforehand and/or offline; said complex can be laminated on the first substrate layer in a single step. Laminating of a laminated complex is a particularly suitable and efficient way of forming two or more layers bonded together, in particular the primary substrate layer and the assembly of the intermediate layer and the secondary substrate layer, wherein it is in addition possible that the respective compositions of the individual layers differ substantially from each other.

According to some embodiments, said laminated complex is formed by the steps:
providing the secondary substrate layer,
coating said secondary substrate layer with a foamable composition, and
foaming said foamable composition with formation of the intermediate layer.

Formation of the laminated complex by foaming a foamable composition that is coated on the secondary substrate layer allows the single-step formation of a foamed material, and the binding of this foamed material on the secondary substrate layer, which is an efficient way of forming the laminated complex. More preferably, said foamable composition is foamed by heating, with formation of the intermediate layer. The foamable composition and/or the formed intermediate layer possibly comprise a PVC-plastisol.

According to some embodiments, said laminated complex is formed by the steps:
providing the secondary substrate layer,
providing the intermediate layer, and
gluing the intermediate layer and the secondary substrate layer.

Formation of the laminated complex by gluing the intermediate layer and the secondary substrate layer allows the intermediate layer and/or the secondary layer to be formed already beforehand and/or offline.

Preferably, the secondary substrate layer and/or the intermediate layer are submitted to a corona treatment prior to gluing thereof. The corona treatment as described herein allows improved adhesion of the intermediate layer and the secondary substrate layer, with formation of a well attached laminated complex.

According to a further or another embodiment of the second and/or third aspect of the present invention, the intermediate layer has at least one of the following properties:
the intermediate layer has a Shore A hardness that is 10 units lower than the Shore A hardness of the primary and/or secondary substrate layer;
the intermediate layer has an elastic modulus that is at least 10.0% lower than the elastic modulus of the primary and/or secondary substrate layer;
the intermediate layer comprises a material with a substantially open cell structure; or
the intermediate layer comprises a foamed thermoplastic material or a foamed thermosetting material.

The various embodiments of the methods according to the second and/or third aspect are exceptionally suitable for manufacturing a panel wherein the intermediate layer has at least one of the aforementioned properties. In particular, coextrusion, lamination and/or the formation of a laminated complex allow the intermediate layer, the primary and/or the secondary substrate layer to have mutually a substantially different composition and/or different material properties, with formation of a panel that displays sufficient stability and adhesion between the various layers.

The intermediate layers as described herein ensure that the panels display better sound damping. This is particularly important with panels that are used as floor panels. The intermediate layers as described herein ensure additionally and/or alternatively that the panels display improved walking comfort.

According to some embodiments, the intermediate layer has a Shore A hardness that is 10 units lower than the Shore A hardness of the primary and/or secondary substrate layer. Preferably the intermediate layer has a Shore A hardness that is 11 units lower than the Shore A hardness of the primary and/or secondary substrate layer, more preferably 12 units lower, even more preferably 13, 14, 15, 16, 17, 18, 19 or 20 units lower. With increasing preference, the various embodiments as described herein ensure a further improvement in the sound damping and/or walking comfort of the panels.

According to a further or another embodiment, the intermediate layer has an elastic modulus that is at least 10.0% lower than the elastic modulus of the primary and/or secondary substrate layer. The intermediate layer, and in particular the lower elastic modulus relative to the primary and/or secondary substrate layer, provides an improvement in the sound-absorbing properties of the panel, and improves the walking comfort, in particular when the panel is used as a floor panel. Preferably the intermediate layer has an elastic modulus that is at least 11.0% lower than the elastic modulus of the primary and/or secondary substrate layer, more preferably 12.0% lower, even more preferably 13.0%, 14.0% or 15.0% lower.

According to some embodiments, the intermediate layer comprises a material with a substantially open cell structure. According to some embodiments the intermediate layer comprises a foamed thermoplastic material or a foamed thermosetting material. These embodiments provide a panel with improved sound damping and/or improved walking comfort.

According to a further or another embodiment, the intermediate layer has a Shore A hardness that is 10 units lower than the Shore A hardness of the secondary substrate layer and/or the intermediate layer has an elastic modulus that is at least 10.0% lower than the elastic modulus of the secondary substrate layer. The panel then has a relatively hard secondary substrate layer, and then imparts sufficient stiffness to the panel, wherein the relatively soft intermediate layer imparts improved sound damping and/or improved walking comfort to the panel.

According to a further or another embodiment, the intermediate layer comprises a foamed thermoplastic material or a foamed thermosetting material, wherein the foamed thermoplastic material or the foamed thermosetting material has an empty cell volume between 10.0 and 80.0 vol %. The empty cell volume in the range as described herein is optimally suitable for improving the sound-absorbing properties of the panel.

According to a further or another embodiment, the aforementioned foamed thermoplastic material is selected from the group of ethylene vinyl acetate (EVA), irradiation-crosslinked polyethylene (IXPE), irradiation-crosslinked polypropylene (IXPP), expanded polyethylene (EPE), expanded polyethylene copolymer (EPC), polypropylene (PP), polyvinyl chloride (PVC), PVC-plastisol, polyurethane (PU), or combinations thereof. These materials are optimally suitable as intermediate layer and provide the panel with improved sound-absorbing properties and/or improved walking comfort. Preferably, the aforementioned foamed thermoplastic material is selected from the group of ethylene vinyl acetate (EVA), irradiation-crosslinked polyethylene (IXPE), expanded polyethylene (EPE), polyvinyl chloride (PVC), PVC-plastisol, polyurethane (PU), or combinations thereof. Most preferably, the aforementioned foamed thermoplastic material is ethylene vinyl acetate (EVA).

According to a further or another embodiment, the aforementioned foamed thermoplastic material has a density that is between 100 and 200 kg/m³, preferably between 100 and 150 kg/m³, more preferably between 120 and 140 kg/m³. With increasing preference the aforementioned densities are extremely advantageous in providing improved sound-absorbing properties and/or improved walking comfort.

According to some embodiments, said primary substrate layer comprises polyvinyl chloride (PVC). Preferably, the polyvinyl chloride has a concentration of at least 95 wt %, more preferably at least 99 wt %, most preferably 100 wt %.

It is possible that the primary substrate layer further comprises one or more fillers selected from the group of inorganic fillers, such as chalk, lime and/or talc, or organic fillers, such as wood, bamboo and/or cork, or mineral fillers. According to a further or other embodiments, said primary substrate layer comprises polyvinyl chloride (PVC) and calcium carbonate (CaCO₃) as filler.

According to some embodiments, the calcium carbonate (CaCO₃) has a concentration of at most 80 wt % and the polyvinyl chloride (PVC) has a concentration of at least 20 wt %. Preferably, the calcium carbonate (CaCO₃) has a concentration between 10 and 80 wt % and the polyvinyl chloride (PVC) has a concentration between 20 and 90 wt %.

More preferably, the calcium carbonate (CaCO₃) has a concentration between 60 and 80 wt % and the polyvinyl chloride (PVC) has a concentration between 20 and 40 wt %. It was found that particularly good stiffness and/or stability is achieved when the proportion of calcium carbonate is greater than the proportion of PVC. Preferably, the calcium carbonate (CaCO₃) has a concentration between 65 and 80 wt % and the polyvinyl chloride (PVC) has a concentration between 20 and 35 wt %. More preferably, the calcium carbonate (CaCO₃) has a concentration between 70 and 80 wt % and the polyvinyl chloride (PVC) has a concentration between 20 and 30 wt %. Most preferably the calcium carbonate (CaCO₃) has a concentration of 75 wt % and the polyvinyl chloride (PVC) has a concentration of 25 wt %.

According to some embodiments, said secondary substrate layer comprises polyvinyl chloride (PVC). According to some embodiments, the polyvinyl chloride has a concentration of at least 95 wt %, more preferably at least 99 wt %, most preferably 100 wt %.

Preferably, said secondary substrate layer comprises plasticizers in an amount of less than 15 phr, preferably of less than 10 phr, more preferably of less than 5 phr.

The various embodiments as described herein provide a secondary substrate layer that imparts sufficient stability and/or stiffness to the panel.

According to a further or another embodiment, said secondary substrate layer is configured to increase the stiffness of the panel, wherein the secondary substrate layer has at least one of the following properties:
the secondary substrate layer comprises a reinforcing layer;
the secondary substrate layer comprises calcium carbonate (CaCO₃) as filler; or
the secondary substrate layer has a thickness of at least 2.0 mm.

According to some embodiments, said secondary substrate layer comprises a reinforcing layer. A suitable reinforcing layer is for example a glass fiber layer. The secondary substrate layer possibly comprises alternative and/or additional reinforcing layers in order to increase the stiffness further.

According to some embodiments, said secondary substrate layer comprises calcium carbonate (CaCO₃) as filler, in which the calcium carbonate (CaCO₃) has a concentration of at most 80 wt % and the polyvinyl chloride (PVC) has a concentration of at least 20 wt %. Preferably, the calcium carbonate (CaCO₃) has a concentration between 10 and 80 wt % and the polyvinyl chloride (PVC) has a concentration between 20 and 90 wt %.

More preferably, the calcium carbonate (CaCO₃) has a concentration between 60 and 80 wt % and the polyvinyl chloride (PVC) has a concentration between 20 and 40 wt %. It was found that particularly good stability and/or stiffness is achieved when the proportion of calcium carbonate is greater than the proportion of PVC. Preferably, the calcium carbonate (CaCO₃) has a concentration between 65 and 80 wt % and the polyvinyl chloride (PVC) has a concentration between 20 and 35 wt %. More preferably, the calcium carbonate (CaCO₃) has a concentration between 70 and 80 wt % and the polyvinyl chloride (PVC) has a concentration between 20 and 30 wt %. Most preferably the calcium carbonate (CaCO₃) has a concentration of 75 wt % and the polyvinyl chloride (PVC) has a concentration of 25 wt %.

According to a further or another embodiment, the secondary substrate layer has a thickness of at least 2.0 mm, which imparts improved stiffness and/or stability to the panel. Preferably, the secondary substrate layer has a thickness of at least 2.1 mm, 2.2 mm, 2.3 mm, 2.4 mm or 2.5 mm. According to some embodiments, the secondary substrate layer may, however, also have a thickness that is less than 2.0 mm. In particular, it is possible that the secondary substrate layer has a thickness that is between 0.5 and 2.0 mm, preferably between 0.5 and 1.5 mm, more preferably between 0.5 and 1.0 mm, most preferably between 0.5 and 0.8 mm. A secondary substrate layer with a small thickness according to the present embodiment is particularly advantageous if it is combined with a high filler content. In particular it is possible that the secondary substrate layer comprises calcium carbonate (CaCO₃) at a concentration between 60 and 80 wt % and comprises polyvinyl chloride (PVC) at a concentration between 20 and 40 wt %, wherein the secondary substrate layer has a thickness between 0.5 and 2.0 mm, preferably between 0.5 and 1.5 mm, more preferably between 0.5 and 1.0 mm, most preferably between 0.5 and 0.8 mm.

According to a further or another embodiment, the thickness of the secondary substrate layer and the thickness of the intermediate layer are in proportion to one another according to a ratio that is between 10:10 and 2:10, preferably between 10:10 and 3:10, more preferably between 10:10 and 4:10. In the respective embodiment an optimal equilibrium is obtained between sound-absorbing properties, walking comfort and strength and/or stability of the panel. Most preferably, the thickness of the secondary substrate layer and the thickness of the intermediate layer are in proportion to one another according to a ratio that is between 8:10 and 4:10.

According to a practical embodiment, it is possible that the intermediate layer has a thickness between 0.5 and 2.0 mm, preferably between 0.7 and 1.8 mm, more preferably between 0.9 and 1.6 mm, for example such as 1.0 mm or 1.5 mm.

According to a further or another embodiment, the aforementioned panel is provided on at least two opposite edges with coupling means, wherein on the respective edges, locking is brought about at least in a vertical direction perpendicular to the plane of the panels and/or at least in a horizontal direction in the plane of the panels and perpendicular to the edges. Owing to the coupling means as described herein, different panels can be coupled to each other in a simple and stable manner.

Preferably at least one of the aforementioned edges is provided with a groove, wherein this groove is flanked by an upper lip and a lower lip, wherein said intermediate layer extends substantially through the upper lip. More preferably, the lower surface of the upper lip is formed at least partially in said primary substrate layer. Even more preferably, the aforementioned upper lip is formed substantially in the primary substrate layer, the intermediate layer and the secondary substrate layer. The embodiments as described herein have the advantage that the upper lip has excellent stiffness, so that good-quality, durable coupling is obtained between the coupling means. Furthermore, the presence of the intermediate layer in the upper lip ensures that when coupling and/or uncoupling adjacent floor panels, the upper lip allows slight compression and/or deformation, so that this coupling and/or uncoupling takes place efficiently, and wherein the risk of permanent deformation of the upper lip, for example through breakage, is reduced.

According to some embodiments, in a coupled state between two adjacent panels, the intermediate layers of said adjacent panels press against each other, wherein a seal forms along the edges of said panels. Said seal further improves the sound-absorbing properties between adjacent panels.

According to some other embodiments, in a coupled state between two adjacent panels, the intermediate layers of said adjacent panels do not touch each other, wherein a space forms between said intermediate layers along the edges of said panels.

According to some embodiments, the coupling means are configured for coupling together the first edge of such a panel to the second edge of another such panel, preferably wherein the coupling parts comprise locking parts for locking such a panel coupled with its first edge to the second edge of another such panel in the direction perpendicular to the plane of the coupled panels and/or in the direction perpendicular to the coupled edges and in the plane of the panels, and wherein on the first edge there is a coupling part in the form of a tongue and on the second edge there is a coupling part in the form of a groove, wherein the groove is delimited by a lower lip and an upper lip, wherein the upper lip is located on the upper side of the panel, and wherein on the upper side the panel comprises a first sealing face on the first edge, wherein the distal end of the upper lip comprises a second sealing face, wherein the first sealing face and the second sealing face are configured so that in the coupled state of such a panel with its first edge on the second edge of another such panel, the first sealing face of said panel comes into contact with or is tightly against the second sealing face of the other such panel.

The coupling means as described herein are in some embodiments provided on a first, and a second opposite edge. According to some embodiments the coupling means as described herein are on a first, and a second opposite edge, as well as on a third, and a fourth opposite edge.

According to a further or another embodiment, the panel obtained is a floor panel or wall panel.

The methods as described in the second and third independent aspect of the present invention, in its various embodiments, preferably provide a reason for manufacturing a panel according to the first independent aspect, in its various embodiments.

With a view to better illustration of the features of the invention, a preferred embodiment is described hereunder, as an example without any limiting character, referring to the appended drawing, in which:

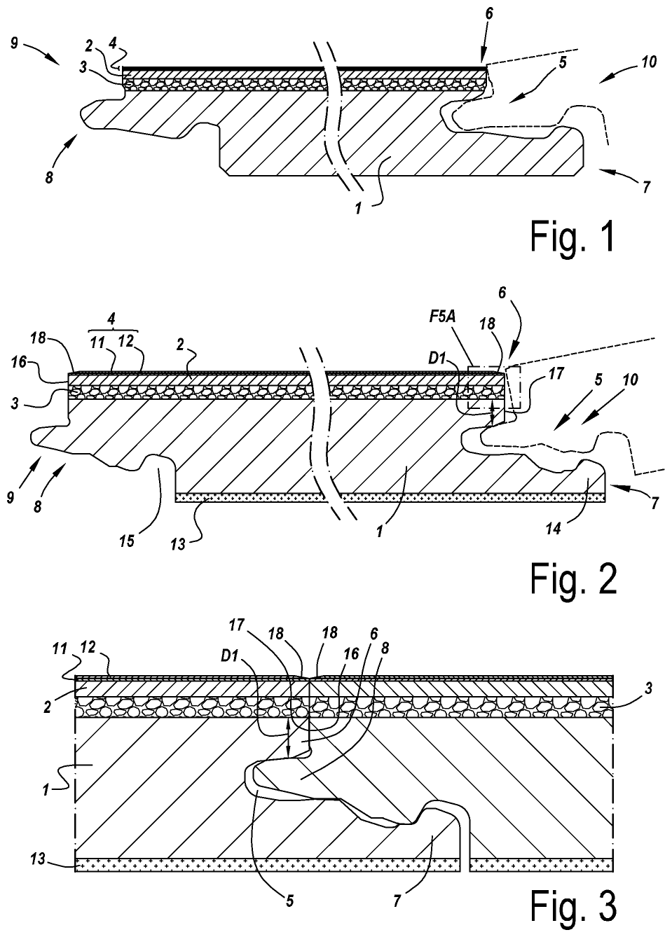

FIGS. 1 and 2 show panels with the features of the invention, comprising a first and a second edge;

FIG. 3 shows two panels as in FIG. 2 in the coupled state;

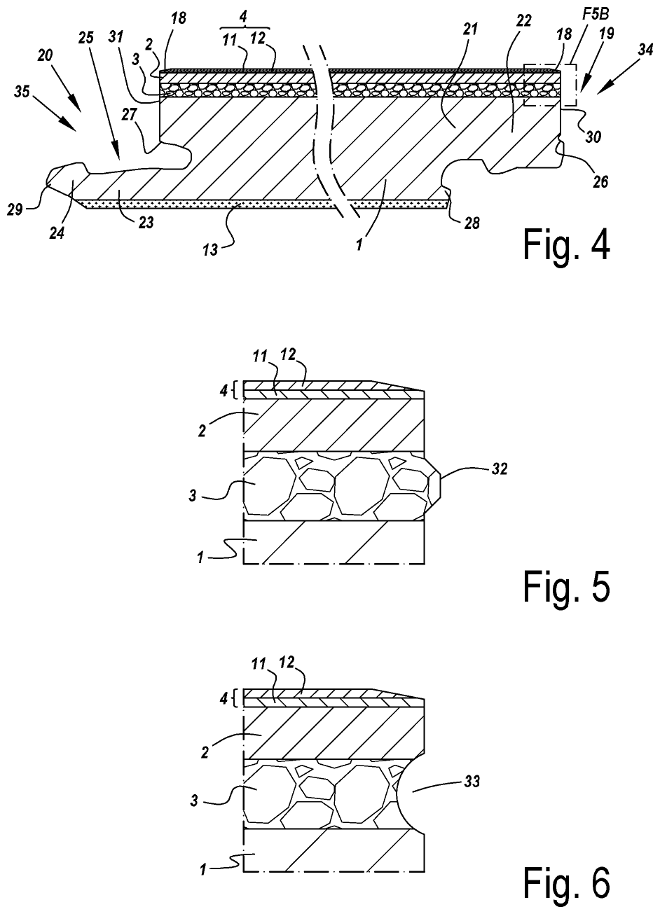

FIG. 4 shows a panel with the features of the invention, comprising a third and a fourth edge;

FIGS. 5 and 6 show specific configurations of edges of panels according to the invention;

FIGS. 7, 8 and 9 illustrate methods for manufacturing a panel, with the features of the invention in its second aspect;

FIG. 10 illustrates a method for manufacturing a panel, with the features of the invention in its third aspect; and

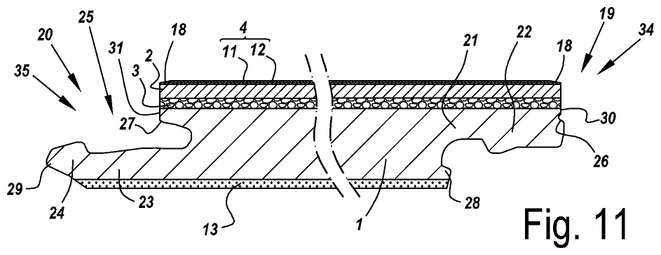

FIG. 11 shows a variant of a panel according to the invention.

FIG. 1 shows a panel 1 according to the invention, and comprises a primary 1 and a secondary substrate layer 2, an intermediate layer 3, and a top layer 4, wherein said intermediate layer 3 is located between said primary 1 and secondary substrate layer 2, and wherein said top layer 4 is applied on the secondary substrate layer 2, characterized in that the intermediate layer 3 has at least one of the following properties:
the intermediate layer 3 has a Shore A hardness that is 10 units lower than the Shore A hardness of the primary 1 and/or secondary substrate layer 2;
the intermediate layer 3 has an elastic modulus that is at least 10.0% lower than the elastic modulus of the primary 1 and/or secondary substrate layer 2;
the intermediate layer 3 comprises a material with a substantially open cell structure; or
the intermediate layer 3 comprises a foamed thermoplastic material.

The intermediate layer 3 of the panel as shown herein possibly comprises a foamed thermoplastic material or a foamed thermosetting material, wherein the foamed thermoplastic material or the foamed thermosetting material has an empty cell volume between 10.0 and 80.0 vol %. Suitable foamed thermoplastic or foamed thermosetting materials are possibly selected from the group of ethylene vinyl acetate (EVA), irradiation-crosslinked polyethylene (IXPE), irradiation-crosslinked polypropylene (IXPP), expanded polyethylene (EPE), expanded polyethylene copolymer (EPC), polypropylene (PP), polyvinyl chloride (PVC), PVC-plastisol, polyurethane, or combinations thereof.

It is clear from FIGS. 1 and 2 that said panel is provided with coupling means on at least two opposite edges, wherein on the respective edges, locking is brought about at least in a vertical direction perpendicular to the plane of the panels and/or at least in a horizontal direction in the plane of the panels and perpendicular to the edges. Herein, at least one of the aforementioned edges is provided with a groove 5, wherein this groove 5 is flanked by an upper lip 6 and a lower lip 7, wherein said intermediate layer 3 extends substantially through the upper lip 6, in particular wherein the lower surface of the upper lip 6 is formed at least partially in said primary substrate layer 1, more particularly wherein the aforementioned upper lip 6 is formed substantially in the primary substrate layer 1, the intermediate layer 3 and the secondary substrate layer 2. As shown, the coupling means then comprise mutually interacting coupling parts, namely the groove 5 as described herein, and a tongue-shaped element, the tongue 8. In particular, further reference is made to the edges constituting the first edge 9, comprising the tongue 8, and to the second edge 10, comprising the groove 5, said groove 5 being flanked by the upper lip 6 and the lower lip 7. The lower lip 7 extends farther than the upper lip 6. The tongue 8 and the groove 5 provide, in the coupled state, locking in the direction perpendicular to the plane of the coupled panels.

FIGS. 2 and 3 further show that the top layer 4 comprises a decorative layer 11 and a wear-resistant layer 12. The panel further comprises a damping layer 13 applied to the underside. The coupling means as shown in FIGS. 2 and 3 relate to the lower lip 6, which comprises a vertical locking part 14 which, together with a recess 15 on the underside of the tongue 8, provides, in the coupled state, locking perpendicular to the coupled edges and in the plane of the coupled panels.

The intermediate layer 3 is located over its entire thickness in the upper lip 6. The minimum thickness DI of the primary substrate 1 in the upper lip 6 and under the intermediate layer 3 in the section where in the coupled state of a panel with its first edge 9 on the second edge 10 of another such panel, the tongue 8 of the first panel comes into contact with the upper lip 6 of the second panel, is preferably at least 0.4 mm, and more preferably at least 0.5 mm and even more preferably at least 1.0 mm.

On the decorative side, i.e. the upper side, the panel comprises a first sealing face 16 on the first edge 9. The distal end of the upper lip 6 comprises a second sealing face 17. The first sealing face 16 and second sealing face 17 are configured so that in the coupled state of such a panel with its first edge 9 on the second edge 10 of another such panel, the first sealing face 16 of said panel comes into contact with or is tightly against the second sealing face 17 of the other such panel.

The coupling parts on the first edge 9 and the second edge 10 of the panel in FIG. 2 are configured so that the panel can be coupled with its first edge 9 on the second edge 10 of another such panel by means of a rolling movement and/or by means of a sliding movement substantially parallel to the plane of the panels, so that snapping occurs. The panel shown in FIGS. 2 and 3 further comprises a chamfer 18 on the first edge 9 and on the second edge 10. Such chamfers are optional in the context of the invention.

FIG. 4 shows an example of the third edge 19 and the opposite fourth edge 20 of a panel according to the invention. This relates to the same panel whose first edge 9 and second edge 10 are shown in FIG. 2. The same reference numbers thus have the same meaning.

The panel comprises, on its third edge 19, a coupling part formed by a downward directed upper hook-shaped portion. This upper hook-shaped portion comprises a lip 21 with a downward directed locking element 22 that forms a male part. The panel comprises, on the fourth edge 20, a coupling part formed by an upward directed lower hook-shaped portion. This lower hook-shaped portion consists of a lip 23 with an upward directed locking element 24 that defines, proximally thereto, a female part in the form of a recess 25. These coupling parts are configured for coupling together the third edge 19 of such a panel to the fourth edge 20 of another such panel, wherein during coupling of the third edge 19 of such a panel to the fourth edge 20 of another such panel, the male part engages in the female part, wherein locking is produced in the direction in the plane of the panels and perpendicular to the coupled edges 19, 20.

The coupling parts 34, 35 on the third edge 19 and on the fourth edge 20 comprise a first pair of locking parts 26, 27 which, together in the coupled state, provide locking of the coupled panels in the direction perpendicular to the coupled edges. The coupling parts 34, 35 on the third edge 19 and on the fourth edge 20 comprise a second pair of locking parts 28, 29 which, together in the coupled state, provide locking of the coupled panels in the direction perpendicular to the coupled edges.

The distal end of the lip 21 of the upper hook-shaped portion comprises a third sealing face 30. The proximal end of the fourth edge 20 comprises a fourth sealing face 31. The third sealing face 30 and the fourth sealing face 31 are configured so that in the coupled state of such a panel with its third edge 19 on the fourth edge 20 of another such panel, the third sealing face 30 of said panel comes into contact with or is tightly against the fourth sealing face 31 of the other such panel.

It can also be seen in FIGS. 1 to 4 that the intermediate layer 3 is thicker than the secondary substrate layer 2. In particular the thickness of the secondary substrate layer 2 and the intermediate layer 3 are in proportion to one another according to a ratio between 8:10 and 4:10. Thus, the thickness of the intermediate layer 3 is for example 1.0 or 1.5 mm and the thickness of the secondary substrate layer 2 is about 0.7 mm. The intermediate substrate layer consists ideally of ethylene vinyl acetate, preferably with a density between 120 and 140 kg/m³, for example such as 130 kg/m³.

FIGS. 5 and 6 show in detail according to F5A and F5B of the respective FIGS. 2 and 4, specific configurations of the edges of panels according to the invention. In the embodiment in FIGS. 2 and 4, the intermediate layer 3 on both opposite edges 9, 10 or 19, 20 ends in the same vertical plane as the top layer 4.

FIG. 5 shows an embodiment wherein the intermediate layer 3 comprises a bulge 32 on the edge of the panel. This may be made on both opposite edges, or only on one of the pair of opposite edges. This may be produced by suitable milling operations during milling of the coupling parts on the respective edges of the panel. This embodiment has the advantage that in the coupled state between two adjacent panels, the intermediate layers of the adjacent panels press against each other, this forms a seal along the coupled edges of the adjacent panels.

This may be carried out on one of the two pairs of opposite edges (either on the first pair of opposite edges or on the second pair of opposite edges) or on both pairs of opposite edges.

FIG. 6 shows an embodiment wherein, on the edge of the panel, the edge of the intermediate layer 3 is located in a recess 33. This may be carried out on both opposite edges, or only on one of the pair of opposite edges. This may be produced by suitable milling operations during milling of the coupling parts on the respective edges of the panel. In such embodiments, in the coupled state between two adjacent panels, the intermediate layers of the adjacent panels do not touch each other, and a space forms between the intermediate layers on the coupled edges of the coupled panels.

This may be carried out on one of the two pairs of opposite edges (either on the first pair of opposite edges or on the second pair of opposite edges) or on both pairs of opposite edges.

It is also possible that on one edge of the panel, the intermediate layer has a bulge, and on the opposite edge, the edge of the intermediate layer is located in a recess on this edge.

FIG. 7 illustrates a method for manufacturing a panel according to the second aspect of the present invention. In particular, FIG. 7 shows extrusion of a primary substrate layer 1, extrusion of an intermediate layer 3 and laminating of a secondary substrate layer 2. The method illustrated is characterized in that the primary substrate layer 1 and the intermediate layer 3 are formed by coextrusion. For this purpose, it is shown in FIG. 7 that the primary substrate layer 1 is extruded by means of a first extruder 34 and the intermediate layer 3 is extruded by means of a second extruder 35. The first extruder 34 and the second extruder 35 give combined supply to a die 36, wherein the primary substrate layer 1 and the intermediate layer are coextruded. In a next step, the secondary substrate layer 2 is laminated on the coextruded assembly of the primary substrate layer 1 and the intermediate layer 3. The laminating of the secondary substrate layer 2 on the assembly of the primary substrate layer 1 and the intermediate layer 3, as shown in FIG. 7, is possibly carried out by means of a roller 39. The secondary substrate layer 2 is possibly formed offline as a film in order to allow efficient lamination on the assembly of the primary substrate layer 1 and the intermediate layer 3.

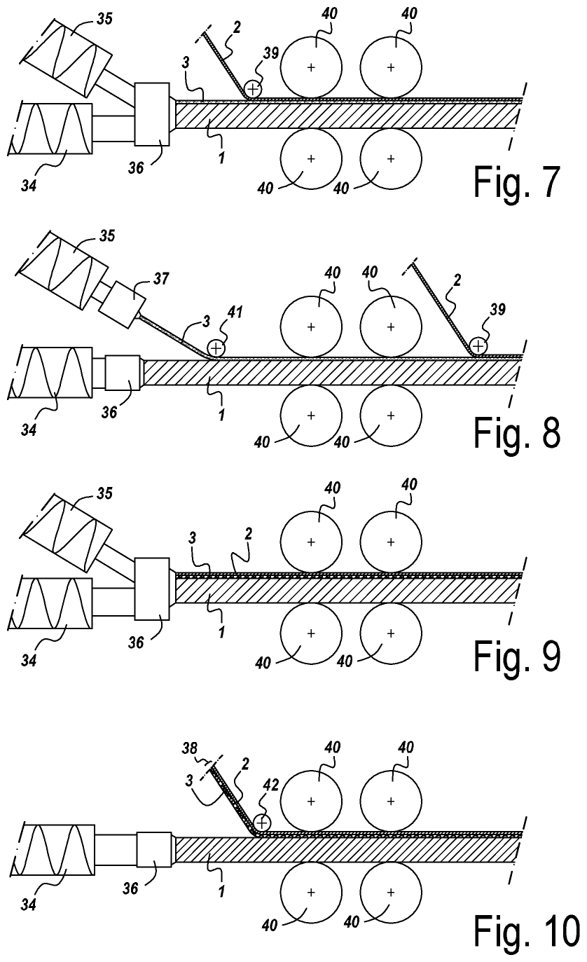

FIG. 8 illustrates a variant of the method for manufacturing a panel according to the second aspect of the present invention, in which the primary substrate layer 1 and the intermediate layer 3 are coextruded, by means of two separate dies 36, 37. Immediately after extrusion, the primary substrate layer 1 and the intermediate layer 3 are possibly fastened to one another by means of a roller 41.

FIG. 9 shows yet another variant of the method according to the second aspect of the present invention, wherein both the primary substrate layer 1, the intermediate layer 3 and the secondary substrate layer 2 are formed by coextrusion. In this case the primary 1 and the secondary substrate layer 2 are formed by means of the first extruder 34 and the intermediate layer 3 is formed by means of the second extruder 35, said material streams being formed by a single die 36.

FIG. 10 shows a method for manufacturing a panel according to the third aspect of the present invention, comprising the following steps: extruding a first substrate layer 1, laminating an intermediate layer 3, and laminating a secondary substrate layer 2, wherein the intermediate layer 3 and the secondary substrate layer 2 together are laminated on the primary substrate layer 1 in the form of a laminated complex 38. According to some embodiments of the method shown here, this laminated complex 38 is formed prior to laminating, by means of the steps (not shown): providing the secondary substrate layer 2, coating said secondary substrate layer 2 with a foamable composition, and foaming said foamable composition with formation of the intermediate layer 3. The intermediate layer 3 and the secondary substrate layer 2 together form the laminated complex 38. Alternatively the laminated complex 38 is formed by means of the steps (not shown): providing the secondary substrate layer 2, providing the intermediate layer 3, and gluing the intermediate layer 3 and the secondary substrate layer 2, with formation of the laminated complex 38. Laminating of the laminated complex 38 on the primary substrate layer 1 is possibly carried out by means of a roller 42.

Each of these methods further comprises the step of laminating a top layer, said top layer possibly consisting of a decorative and/or wear-resistant layer. This step is not shown explicitly in FIGS. 7, 8, 9 and 10. Possibly the primary substrate layer 1, the intermediate layer 3 and the secondary substrate layer 2 making up the assembled material are pressed against each by means of one or more rolls 40.

The methods as shown in each of FIGS. 7-10 are further characterized in that the intermediate layer 3 has at least one of the following properties:
the intermediate layer has a Shore A hardness that is 10 units lower than the Shore A hardness of the primary and/or secondary substrate layer;
the intermediate layer has an elastic modulus that is at least 10.0% lower than the elastic modulus of the primary and/or secondary substrate layer;
the intermediate layer comprises a material with a substantially open cell structure; or
the intermediate layer comprises a foamed thermoplastic material or a foamed thermosetting material.

The intermediate layer of the panel as shown herein possibly comprises a foamed thermoplastic material or a foamed thermosetting material, wherein the foamed thermoplastic material or the foamed thermosetting material has an empty cell volume between 10.0 and 80.0 vol %. Suitable foamed thermoplastic or foamed thermosetting materials are possibly selected from the group of ethylene vinyl acetate (EVA), irradiation-crosslinked polyethylene (IXPE), irradiation-crosslinked polypropylene (IXPP), expanded polyethylene (EPE), expanded polyethylene copolymer (EPC), polypropylene (PP), polyvinyl chloride (PVC), PVC-plastisol, polyurethane, or combinations thereof. According to a practical embodiment, the intermediate layer consists of ethylene vinyl acetate (EVA), preferably with a density between 120 and 140 kg/m³, for example such as 130 kg/m³.

FIG. 11 shows a variant of a panel according to the invention in one and the same view as in FIG. 4. It can be seen from FIG. 11 that the intermediate layer 3 may also be thinner than the secondary substrate layer 2. Thus, the intermediate layer 3 may for example be only half as thick as the secondary substrate layer 2, or more explicitly, the intermediate layer 3 may be only 25%, or even only 10%, as thick as the secondary substrate layer 2.

The present invention is by no means limited to the embodiments described above, but such panels and methods for the manufacture thereof may be realized according to different variants while remaining within the scope of the present invention.

1.-45. (canceled)

46. A panel comprising a primary and a secondary substrate layer, an intermediate layer, and a top layer,
wherein said intermediate layer is located between said primary and secondary substrate layer, and
wherein said top layer is applied on the secondary substrate layer, wherein the intermediate layer has at least one of the following properties:
the intermediate layer has a Shore A hardness that is 10 units lower than the Shore A hardness of the primary and/or secondary substrate layer;
the intermediate layer has an elastic modulus that is at least 10.0% lower than the elastic modulus of the primary and/or secondary substrate layer;
the intermediate layer comprises a material with a substantially open cell structure; or the intermediate layer comprises a foamed thermoplastic material or a foamed thermosetting material,
wherein the shore A hardness is determined in accordance with ASTM standard D2240, in particular ASTM standard D2240-15R21,
wherein the elastic modulus is determined in accordance with ASTM standard E111-17.

47. The panel in accordance with claim 46, wherein the intermediate layer has a Shore A hardness that is 10 units lower than the Shore A hardness of the secondary substrate layer and/or in that the intermediate layer has an elastic modulus that is at least 10.0% lower than the elastic modulus of the secondary substrate layer.

48. The panel in accordance with claim 46, wherein the intermediate layer comprises a foamed thermoplastic material or a foamed thermosetting material,
wherein the foamed thermoplastic material or the foamed thermosetting material has an empty cell volume between 10.0 and 80.0 vol %.

49. The panel in accordance with claim 46, wherein the intermediate layer comprises a foamed thermoplastic material or a foamed thermosetting material,
wherein the foamed material is selected from the group of ethylene vinyl acetate (EVA), irradiation-crosslinked polyethylene (IXPE), irradiation-crosslinked polypropylene (IXPP), expanded polyethylene (EPE), expanded polyethylene copolymer (EPC), polypropylene (PP), polyvinyl chloride (PVC), PVC-plastisol, polyurethane, or combinations thereof.

50. The panel in accordance with claim 46, wherein said primary substrate layer comprises polyvinyl chloride (PVC) and calcium carbonate (CaCO3) as filler,
wherein the calcium carbonate (CaCO3) has a concentration between 60.0 and 80.0 wt % and the polyvinyl chloride (PVC) has a concentration between 20.0 and 40.0 wt %.

51. The panel in accordance with claim 46, wherein said secondary substrate layer comprises polyvinyl chloride (PVC).

52. The panel in accordance with claim 51, wherein said secondary substrate layer comprises plasticizers in an amount of less than 15 phr.

53. The panel in accordance with claim 46, wherein said secondary substrate layer is configured to increase the stiffness of the panel,
wherein the secondary substrate layer has at least one of the following properties:
the secondary substrate layer comprises a reinforcing layer;
the secondary substrate layer comprises calcium carbonate (CaCO3) as filler; or
the secondary substrate layer has a thickness of at least 2.0 mm.

54. The panel in accordance with claim 53, wherein said secondary substrate layer comprises calcium carbonate (CaCO3) as filler,
wherein the calcium carbonate (CaCO3) has a concentration between 60.0 and 80.0 wt % and the polyvinyl chloride (PVC) has a concentration between 20.0 and 40.0 wt %.

55. The panel in accordance with claim 46, wherein the aforementioned panel is provided with coupling means on at least two opposite edges,
wherein on the respective edges, locking is brought about at least in a vertical direction perpendicular to the plane of the panels and/or at least in a horizontal direction in the plane of the panels and perpendicular to the edges.

56. The panel in accordance with claim 55, wherein at least one of the aforementioned edges is provided with a groove,
wherein this groove is flanked by an upper lip and a lower lip, wherein said intermediate layer extends substantially through the upper lip.

57. The panel in accordance with claim 56, wherein the lower surface of the upper lip is formed at least partially in said primary substrate layer.

58. The panel in accordance with claim 56, wherein the aforementioned upper lip is formed substantially in the primary substrate layer, the intermediate layer and the secondary substrate layer.

59. The panel in accordance with claim 55, wherein, in a coupled state between two adjacent panels, the intermediate layers of said adjacent panels press against each other,
wherein a seal forms along the edges of said panels.

60. The panel in accordance with claim 55, wherein, in a coupled state between two adjacent panels, the intermediate layers of said adjacent panels do not touch each other,
wherein a space forms between said intermediate layers along the edges of said panels.

61. A method for manufacturing a panel, comprising the steps:
extruding a primary substrate layer,
extruding an intermediate layer,
extruding and/or laminating a secondary substrate layer, and
laminating a top layer,
wherein at least the primary substrate layer and the intermediate layer are formed by coextrusion.

62. The method in accordance with claim 61, wherein the primary substrate layer, the intermediate layer and the secondary substrate layer are formed by coextrusion.

63. The method in accordance with claim 61, wherein the secondary substrate layer is laminated.

64. The method in accordance with claim 61, wherein said layers that are formed by coextrusion are formed by a single die.

65. The method in accordance with claim 61, wherein said layers which that are formed by coextrusion are formed by two or more separate dies.
